(19) United States
(12) Patent Application Publication
(10) Pub. No.: US 2009/0065278 A1
(43) Pub. Date: Mar. 12, 2009

(54) RIGHT SIDE DRIVE CONVERSION

(76) Inventors: John L. White, Seattle, WA (US); Anthony Muto, Kent, WA (US)

Correspondence Address: AUSTIN RAPP & HARDMAN, 15 WEST SOUTH TEMPLE, SUITE 900, SALT LAKE CITY, UT, 84101, US

(21) Appl. No.: 12/118,347

(22) Filed: May 9, 2008

Related U.S. Application Data
(60) Provisional application No. 60/928,791, filed on May 11, 2007.

(51) Int. Cl. B62D 61/02

(52) U.S. Cl. 180/227

(57) ABSTRACT

A system and apparatus for converting a motorcycle with a left side drive into a motorcycle with a right side drive. This apparatus is particularly suitable for “Indian” brand, “Chief” model motorcycles manufactured in 2002 and thereafter. This apparatus includes a swing arm that facilitates the conversion and enables the use of wider rear wheels. A sprocket and drive pulley will also be added to the right side as part of the conversion process. A cutout in the fender may be added to accomplish the conversion. This apparatus is particularly suitable for “Indian” “PowerPlus Chiefs” (model year 2002 and later).

### CROSS-REFERENCED RELATED APPLICATIONS

This application claims the benefit of U.S. Provisional Application No. 60/928,791, filed May 11, 2007. This prior patent application is expressly incorporated herein by reference.

### BACKGROUND OF THE INVENTION

“Indian” brand motorcycles have been popular for many years. Standard “Indian” brand motorcycles included the drive for the motorcycle on the right side—i.e., on the rider's right side when the rider was facing forward.

However, in 2002, the new company out of Gilroy, Calif. began producing a 2002 “Indian” brand motorcycle, namely “Indian” brand “Chief” models. This company produced a variety of “Chief” model motorcycles model year 2002 and later including the “Standard,” “Roadmaster,” Springfield,” and “Vintage”. (The “Vintage” was made in 2003 only). All of these submodels of the “Chief” motorcycle which either 2002 model year or after will be referred to herein as the “PowerPlus Chief.” For example, on the “PowerPlus Chief” models, the drive was placed on the left side—i.e., on the rider's left side when the rider was seated and facing forward. For the “Indian” motorcycle enthusiast familiar with the earlier, original “Indian” models, this was an unwelcomed change. This was a departure from the well-known “Indian” look. The left side drive also came with various disadvantages. For example, the left side drive prevents the use of a wider rear tire. Using such wider rear tires has become popular and actually helps stabilize the motorcycle. However, with this new left-side position of the drive on the “PowerPlus Chief” model, the use of this wider rear tire is not possible.

Further, for those left side drive motorcycles, it can become difficult to replace the belt (i.e., the drive belt) in the event that this belt fails. This repair will generally take several hours and requires special tools that are not usually carried by the rider. As a result, if the belt breaks on a left side drive motorcycle, the rider is usually forced to have the motorcycle towed to the nearest shop for repairs.

Accordingly, it would be an advancement to provide a right side drive for motorcycles, and more specifically, for “Indian” motorcycles manufactured in Gilroy, Calif. beginning with the 2002 model year Chief models. This conversion returns the motorcycle to its classic look.

### BRIEF SUMMARY OF THE INVENTION

The present embodiments relate to converting a motorcycle with a left side drive to a right side drive. Again, the left side is the rider's left side when he is seated and facing forward. The right side is the rider's right side when the rider is seated and facing forward. This conversion may be done readily (in the field) and may be done with basic hand tools. The right side drive allows for a wider rear tire and a more balanced chassis. The drive pulley remains under the fender (on the inside of the fender) to allow for the use of saddlebags.

To accomplish the conversion, a small belt cover is removed. This belt cover is sometimes called the shroud or guard. The transmission drive pulley cover is also removed. The most time consuming part of this repair involves adjusting the belt tension. The total time spent may be approximately 30 to 60 minutes rather than 2 to 4 hours on conventional motorcycles. Generally, it is better to use a belt drive in these embodiments. While the use of a chain is clearly possible (and within the scope of the present embodiments), there may be issues involving the wear, maintenance, strength, noise and clean operation (i.e., grease flings everywhere) that make the use of the belt drive more desirable.

The conversion from a left side drive to a right side drive may be accomplished readily by changing the following:

replacement of the left-side drive transmission existing on the Gilroy Indian motorcycle with a new right-side drive transmission (to do this chain from the engine to the left-side transmission must be removed along with any covers shielding the chain);

modifying the rear fender to allow belt clearance so that the fender will not interfere with the belt;

adding a belt cover to shield the belt;

relocating the rear brake to the left side (which may involve using a caliper, hose, and bracket);

inserting a pulley spacer;

obtaining and installing a custom axle;

obtaining and installing a swing arm within the present embodiments; and

modifying the exhaust and/or repositioning the oil tank filler neck so that each will not interfere with the belt.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is a rear, representative view of a prior art “Indian” brand “PowerPlus Chief” motorcycle having a left side drive;

FIG. 1B is a view of an Indian” brand “PowerPlus Chief” motorcycle having a right side drive, wherein the left side drive of FIG. 1A has been converted to a right side drive according to the present embodiments;

FIG. 1C is a right side view of a motorcycle that has been converted from a left side drive to a right side drive;

FIG. 2 is a perspective view of a swing arm used in the conversion of the motorcycle of FIG. 1C;

FIG. 3 is a perspective view of the swing arm of FIG. 2 as well as the sprockets being added to a motorcycle to accomplish the conversion of the motorcycle to a right side drive; and

FIG. 4 is a another perspective view of the assembly of FIG. 3 showing a spacer between the sprocket and the rear wheel;

FIG. 5 is a perspective view of the embodiment of FIG. 3 in which a rear fender has been added;

FIGS. 5A and 5B are top views showing additional features of the struts that may be used with the present embodiments; and

FIG. 6 is another embodiment of a strut that may be used with the present embodiments.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the present embodiments, as represented in the Figures, is not intended to limit the scope of the invention, as claimed, but is merely representative of presently preferred embodiments of the invention.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

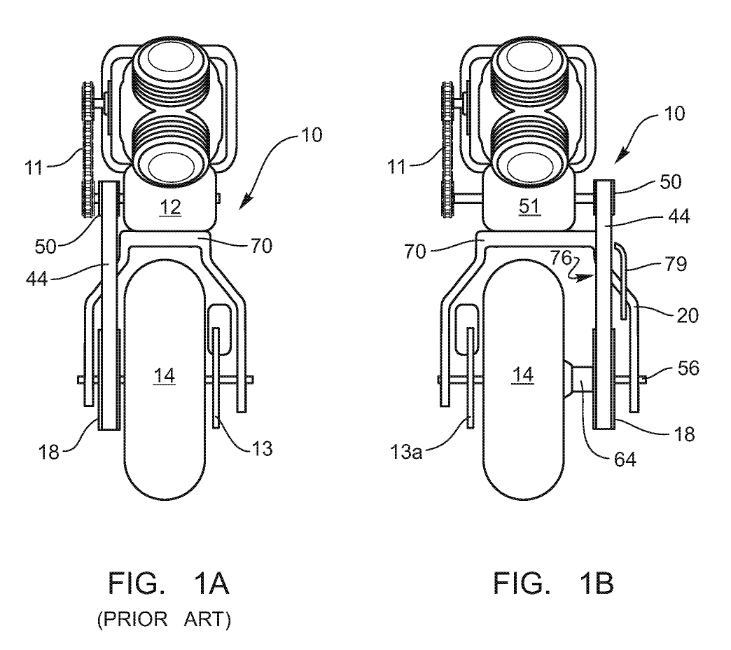

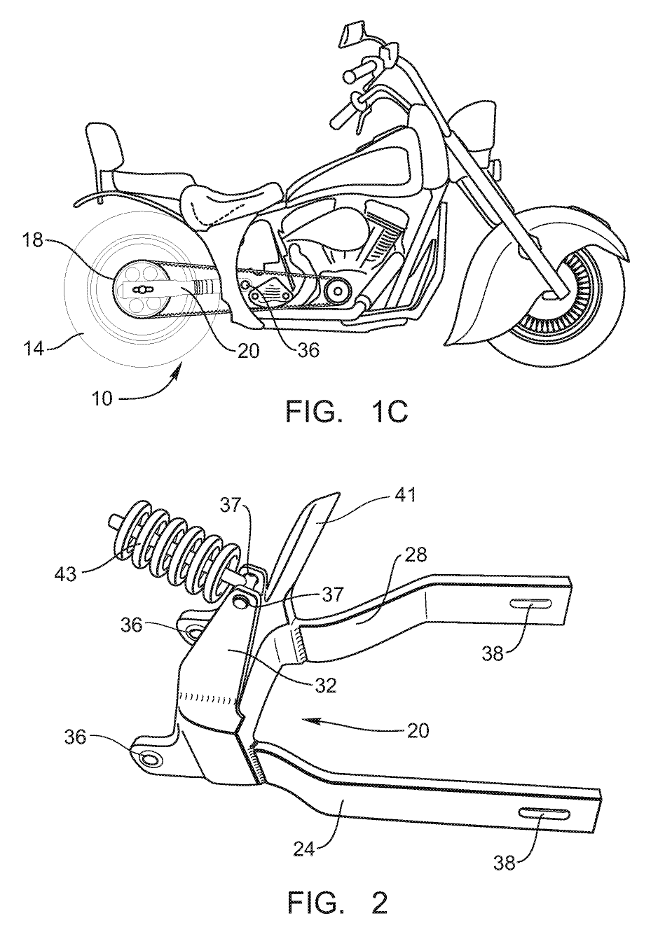

FIG. 1A represents the prior art, namely a “PowerPlus Chief” motorcycle manufactured after 2002 with a left side drive. In other words, this is a motorcycle 10 that has a chain drive 11 that attaches to a transmission 12. The transmission 12 is connected to a sprocket 50 and a belt 44. The belt 44 extends rearwards to a pulley 18 on the rear wheel 14. The pulley 18, the sprocket 50, and the belt 44 are on the left side of the motorcycle 10. A fender 70 covers the rear wheel 14. A rear brake 13 is added to the right side of the rear wheel 14.

Referring now to FIGS. 1B and 1C, the motorcycle 10 has been converted to a right side drive motorcycle. (FIG. 1C is a right side view illustrates a motorcycle 10 that has been retro-fit according to the present embodiments whereas FIG. 1B is a view similar to that which is shown in FIG. 1A). Specifically, the motorcycle 10 was one that initially had a left side drive but has been retro-fit (converted) so that now it has a right side drive. There are a variety of safety factors that would prompt the use of a right side drive instead of a left side drive. For example, using a right side drive may reduce the likelihood that the chain or belt will bind in the primary shroud.

Further, a right side drive reduces the level of expertise required in changing the belt. To hold the belt in place, simple cotter pins may be used rather than a lock washer. Such cotter pins are easier to change and work with. Cotter pins, if used, are to be installed by common practice (such as using a castellated nut etc). By making it easier to change, there is less likelihood that an error will be committed during this repair process. This increase in simplicity increases the inherent safety of the motorcycle. Also, the repair time associated with the motorcycle is drastically decreased. For example, an “Indian” shop manual indicates that several hours may be required to replace the belt. However, by having the drive on the right side, much less time is needed to replace the belt.

As shown in FIG. 1C, the motorcycle includes a rear wheel 14. The rear wheel 14 will be attached to a drive pulley 18. In turn, a belt 44 (not visible in FIG. 1C) will be used turn to the wheel 14 and allow the motorcycle to move. The belt and the pulley make up the motorcycle's “drive” or drive system. Thus, by placing the belt and pulley 18 on the right side of the motorcycle, the vehicle now has a right side drive, rather than a left side drive. The motorcycle 14 also includes a swing arm 20, as will be shown herein. It is the use of this swing arm 20 that allows the drive to be moved (retro-fit) from the left side to the right side.

Thus, as shown in FIG. 1B, the chain drive 11 extends to a transmission 51. This transmission is a right side transmission (rather than the left side transmission of FIG. 1A). Accordingly, the sprocket 50, the belt 44, and the pulley 18 are positioned on the right side. A swing arm 20, which is described herein, makes this conversion possible. As will be described herein, a custom axle 56 and a spacer 64 may be required. The rear brake 13a has been modified and moved from the right side to the left side. Those skilled in the art will appreciate how to move this brake. Likewise, the fender 70, may need to be modified with cutout 76 and modification 79, as described herein.

It should be noted that in lieu of moving the brake from one side to the other, an alternative embodiment would be to use a special pulley/brake combination system. This features a brake within the inside diameter of the pulley, this would simplify installation and allows for a wider tire or more compact (narrower) swingarm.

FIG. 2 is a perspective view of the swing arm 20 that may be used on the motorcycle 10 of FIG. 1C. The swing arm 20 includes a left arm 24 and a right arm 28. The left and right arms 24, 28 are attached to a base plate 32. In the embodiment shown in FIG. 1C, the base plate 32 is positioned between the left and right arms 24, 28. The base plate 32 is designed to be attached pivotally to the frame of the motorcycle. A mud sling 41 may also be added to the arm 20. To this end, the base plate 32 includes one or more pivot holes 36 through which the base plate is pivotally attached to the frame (via, for example, a pivot pin or other fastener). Shock holes 37 are provided for pivotally attaching a shock 43 (also shown in FIG. 4) to provide monoshock suspension for the rear wheel.

The rear wheel 14 of FIG. 1C is designed to fit between the left arm 24 and the right arm 28. The left and right arms 24, 28 are each adapted to be spaced apart from each other to accommodate the width of tire desired and each connected to an end of a custom axle (not shown in FIG. 2). Specifically, the left arm 24 will be connected on one end of the axle and the right arm 28 will be connected to the opposite end of the axle. Accordingly, openings 38 in the arms 24, 28 are provided.

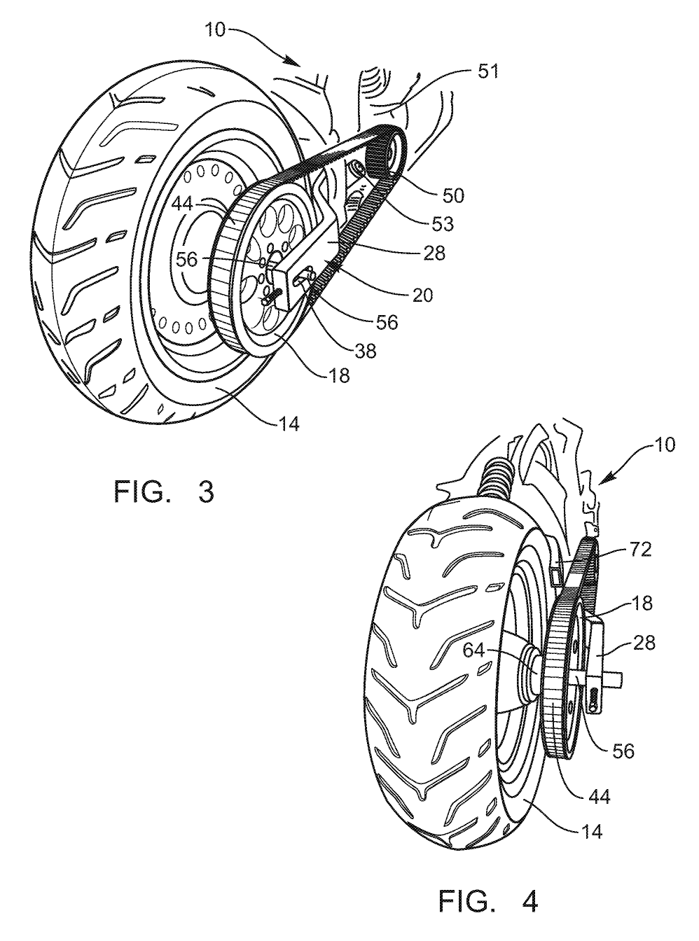

Referring now to FIG. 3, the swing arm 20 is shown mounted on the motorcycle 10. Specifically, the base plate 32 has been bolted to the frame 40 (not shown) of the motorcycle 10 using the pivot holes 36 and shock holes 37. On the right side of the wheel 14, a drive pulley 18 has been mounted. The drive pulley 18 is sometimes referred to as the sprocket. A belt 44 has been wrapped around the pulley 18, as known in the art. The belt 44 also wraps around a corresponding forward sprocket 50. The sprocket 50 is the drive sprocket for the right-side drive transmission 51 which has replaced the left-side drive transmission, as discussed above.) Generally, when the drive pulley 18 is moved to the right side, the position of the drive pulley 18 and the sprocket 50 must be aligned (leveled) to allow for optimum performance. A level, a straight rod, or any other feature capable of leveling/aligning the pulley 18 and the sprocket 50 may be used.

A custom axle 56 has been passed through the drive pulley 18 and the rear wheel 14 and openings 38. The rear wheel 14 is positioned between the left arm 24 (not shown) and the right arm 28. Because the axle 56 will pass through the openings 38 in the swing arm 20, the axle 56 will typically have a length longer than the existing axle (the additional length of the axle 56 accommodates a wider wheel 14), it is preferred that the axle 56 be made of a high strength metal. Of course, this axle 56 may be a “custom axle,” meaning that the size, shape, etc. of the axle may have to be adjusted to fit through the wheel 14, the pulley 18, and the arms 24, 28. Those skilled in the art will appreciate how to obtain (buy) or construct such an axle 56. Further, those skilled in the art will appreciate how to secure or bolt the axle into place so that the motorcycle 10 may be safely operated. Once assembled, the pulley 18 and the sprocket 50 may be used to turn the rear wheel 14 and “drive”—i.e., provide power to the rear wheel 14. Of course, the proper tension on the belt 44 must be obtained in order for the motorcycle to operate efficiently. This belt tensioning step is often the most time-consuming step in this process.

Referring to FIG. 4, another feature of the embodiments is illustrated. Specifically, FIG. 4 illustrates the rear wheel 14 after the drive has been moved to the right side. However, as shown in FIG. 4, a spacer 64 may be inserted (during the assembly process) between the rear wheel 14 and the drive pulley 18. Known features may be used for this spacer 64 (including washers, etc.). This spacer 64 prevents the wheel 14 and the pulley 18 from rubbing against each other, etc. Additional spacers (not specifically shown) can be positioned on the axle 56 so that appropriate spacing is maintained and moving parts do not rub with other moving parts or stationary parts.

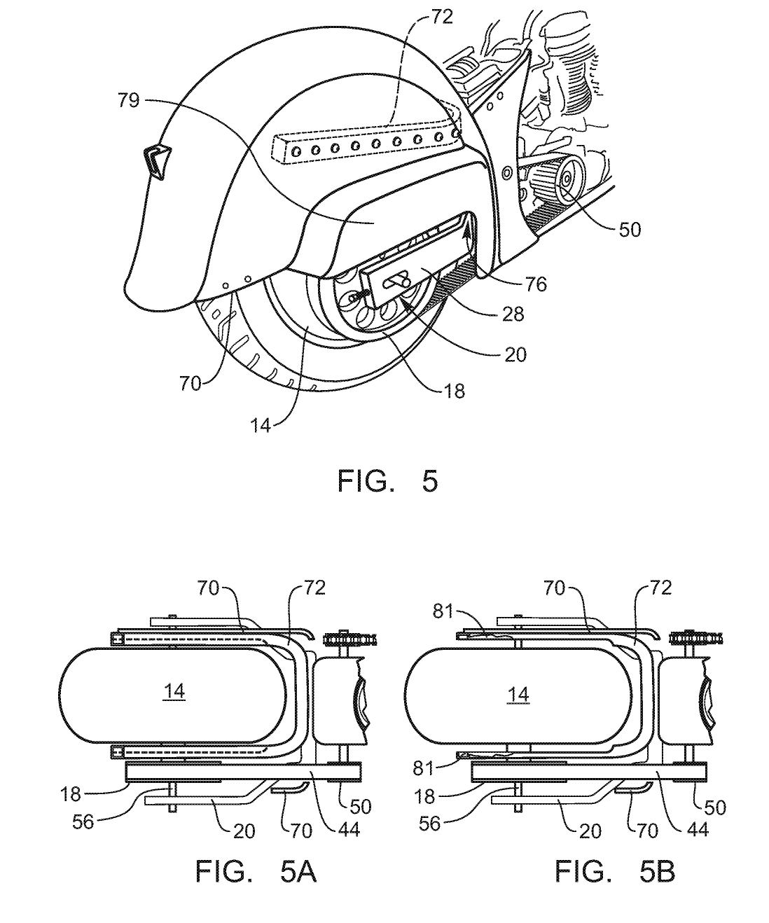

Referring now to FIG. 5, the rear wheel 14 is illustrated after the rear fender 70 has been added. The rear fender 70 is designed to cover the rear wheel 14 and protect the belt 44. However, as shown in FIG. 5, a portion 76 of the fender 70 may need to be cut-out or adjusted to accommodate the swing arm 20. The fender 70 may also need to be modified to allow for belt clearance (i.e., for the belt 44 to rotate around the sprocket 50 and pulley 18 without fender 70 interference). Depending upon the embodiment, the fender 70 may be offset more to the right than its initial position (prior to the modification).

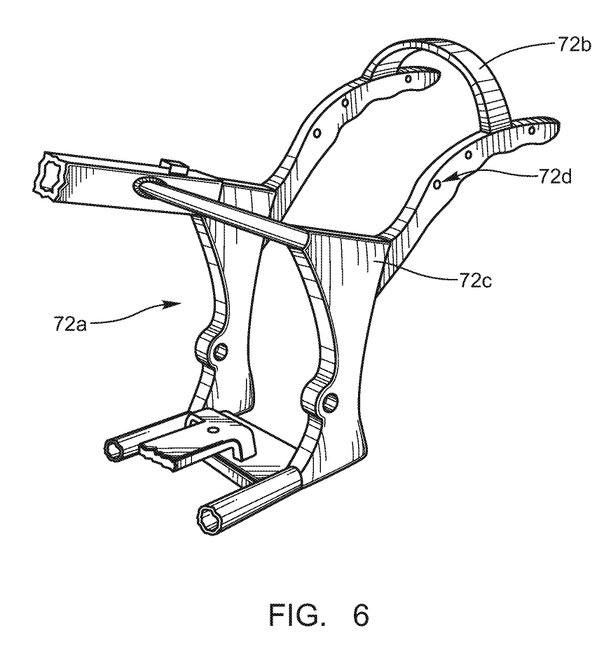

The fender 70 is attached to the frame of the motorcycle 10 via fender struts 72 (shown cutaway in FIG. 4). Depending on the width of rear wheel 14 desired, the fender struts 72 may need to be slightly modified to accommodate the wheel width. This can be done by shaving off some of the inside of each of the fender struts 72. To reinforce the fender struts 72 after shaving off some of the inside structure, a metal reinforcing bar (not shown) can be inserted into the fender strut 72 so that the strut has more substance for connecting the fender 70. FIGS. 5A and 5B show the fender strut 72 in greater detail. Specifically, FIG. 5A shows the situation where the fender strut 72 does not need to be shaved off or modified to accommodate the size of the wheel 14. However, in FIG. 5B, the wheel 14 may be larger such that a portion of the strut 72 has been shaved off. Again, a metal reinforcing bar 81 can be inserted into the strut 72 for reinforcement. The bar 81 may fit entirely within the strut 72 or may protrude out of the strut 72. Those skilled in the art would appreciate how this modification (or other similar modifications, as necessary) may be accomplished. FIG. 6 is another embodiment of a strut 72. This embodiment may be an “shaving off the inside structure” of the strut 72. In this embodiment, the existing strut 72 (sometimes called a “fender support”) is replaced with a section of plate steel that replicates the overall shape of the current fabricated support 72a, as shown in FIG. 6. This structure allows the seat to be in a lower position (in addition to cleaning up the method of fender attachment, better from a manufacturing standpoint and affords more tire clearance width-wise). This embodiment may also operate to relocate the swing arm pivot height. This support 72a may include a cross brace 72b, side plates 72c, and holes 72d to which the fender may be attached Those skilled in the art will appreciate how this or other modifications may be made to the support 72a (or other portions of the motorcycle/frame) may be accomplished. This support 72a may be made of plate steel and may be one-piece, or may be a combination of steel tubing and brackets (although less preferred). It should be noted that FIG. 6 lacks any type of modification for a lower seat. If a motorcyclist wants to make this modification, he or she may do so by modifying the support 72a, if necessary.

Referring now to all of the Figures generally, the process and method for converting the motorcycles from a left side drive to a right side drive will now to be described. When it is desired to convert a left side drive motorcycle (in this case a 2002 or later Indian motorcycle) to a right side drive motorcycle, the first step may involve replacing the left-side drive transmission with a right side transmission. Because the drive belt for left side drive motorcycles is located inside of the drive chain that extends from the engine to the clutch of the transmission, the drive chain must be removed. In removing the drive chain, the housing that encloses the drive chain and houses oil to keep the drive chain lubricated must be removed. Once removed, the left-side drive transmission can be replaced by a right-side drive transmission. Such right-side drive transmissions are commercially available. Those skilled in the art would appreciate how to obtain and install such a transmission. After the right-side drive transmission is installed, the drive chain and its housing with an oil reservoir can be reassembled.

Next, the rear fender 70 should be modified. This may involve cutting a portion 76 of the fender away to allow for the swing arm 20 and/or to allow for proper clearance of the belt 44. Again, those skilled in the art would appreciate how to modify the fender 70 as needed. It may be desired that the fender 70 be modified to extend outward to shield the pulley 18 and belt 44. Such an outward extension of the fender 70 is shown as extension 79 on FIG. 5.

As part of the conversion process, if the fender 70 is not modified to shield the belt 44, a belt cover may need to be added. This belt cover will protect the belt 44 and shield against body parts or clothing from being caught in the belt. Such belt covers are conventional and those skilled in the art will appreciate how such devices may be constructed/obtained/installed and used to protect the belt 44 during operation. (In some embodiments, the belt cover was previously part of the motorcycle and was removed as part of the retro-fit process. This belt cover may be reused as part of the new, right-side drive motorcycle).

In some embodiments of the motorcycle 10, the rear brake must be relocated and adjusted. Specifically, in some embodiments, the rear brake (usually a disk brake) is positioned on the right side. However, in order to move the drive to the right side, the rear brake must be moved to the left side. Again, those skilled in the art will appreciate how this may be accomplished. In some embodiments, this may involve using a bracket, caliper or hose to move the brake to the opposite side. However, such modifications of the brake are well within the skill in the art (as noted above).

Once the brake is moved, the spacer 64 may be positioned between the rear wheel 14 and the pulley 18. (If necessary, an additional spacer may be placed between the pulley 18 and the swing arm 20). Adding the pulley 18 may also involve adding the sprocket 50 and positioning the belt 44 around these features. Of course, these features must first be properly aligned (leveled) and the appropriate belt tension added to the belt 44. Additional spacers may be used as needed.

The axle 56 may be inserted as well. Again, this axle 56 may be a custom axle that has a longer length and is made of a high strength metal. The modification of the shape and size of the axle is known. Once the axle 56 is positioned, the swing arm 20 will be positioned around the wheel 14 and the axle 56 will pass through the openings 38. Once the axle 56 is added, the fender 70 may be installed. Depending upon the particular embodiment, the oil tank filler neck 53 (shown in FIG. 3) (i.e., the portion into which oil may be added into an oil tank) and/or the exhaust pipe may need to be moved, relocated, or modified. These are typically minor adjustments to make certain that that they clear the belt 44 and will not interfere with the smooth and efficient operation of the belt 44. (This may not be the case in all motorcycles, it may depend upon the particular configuration of the motorcycle). For the Chief 2002 (and later) models discussed herein, the oil neck filler 53 and exhaust must be modified to accommodate for the modifications made herein. It should be noted that the position of the filler neck 53 may be changed as desired. For example, in some embodiments, the oil filler neck 53 may actually protrudes just to the rear of the transmission sprocket 50 and is between the upper and lower runs of the belt.

Those skilled in the art will appreciate that this modification and conversion from a left side drive to a right side drive may be easily accomplished. However, depending upon the particular configuration of the motorcycle, additional changes to the motorcycle may be needed to accomplish this conversion/retro-fit. However, again, those skilled in this art will appreciate how such modifications may be accomplished.

1. A swing arm for pivotal attachment to a motorcycle frame to facilitate converting a left side drive motorcycle to a right side drive motorcycle, the swing arm comprising:
a left arm adapted to be connected to an end of an axle;
a right arm adapted to be connected to the opposite end of the axle; and
a base plate that is disposed between the left arm and the right arm for attaching to the motorcycle frame; the right arm being spaced from the left arm such that a drive pulley may be disposed intermediate the right arm and a motorcycle wheel.

2. A system for converting a left side drive motorcycle into a right side drive motorcycle, comprising:
a swing arm for pivotal attachment to a motorcycle frame, the swing arm comprising:
a left arm adapted to be connected to an end of an axle;
a right arm adapted to be connected to the opposite end of the axle; and
a base plate that is disposed between the left arm and the right arm for attaching to the motorcycle frame; the right arm being spaced from the left arm such that a drive pulley may be disposed intermediate the right arm and a motorcycle wheel.

3. A system as in claim 2 further comprising a spacer between the drive pulley and the motorcycle wheel.

4. A system as in claim 2 wherein a drive belt is positioned around the pulley.

5. A system as in claim 3, further comprising a modified rear fender that shields but does not interfere with the drive belt.

6. A system as in claim 2, wherein an axle passes through the left arm and the right arm.

7. A method for converting a left side drive motorcycle to a right side drive motorcycle comprising the steps of:
modifying the rear fender to provide clearance of a drive belt so not to interfere with the belt;
obtaining and installing a right-side drive transmission having a right-side drive sprocket;
obtaining and installing a swing arm comprising a base plate and a left arm and a right arm each with an axle opening;
obtaining and installing an axle;
obtaining and installing a motorcycle wheel on the axle;
obtaining and installing a pulley on the axle;
inserting a pulley spacer between the pulley and the motorcycle wheel; and
installing the drive belt about the pulley and the drive sprocket.
